(19) United States
(12) Patent Application Publication
(10) Pub. No.: US 2017/0048078 A1
(43) Pub. Date: Feb. 16, 2017

(54) METHOD FOR CONTROLLING DEVICE AND THE DEVICE THEREOF

(71) Applicant: Xiaomi Inc., Beijing (CN)

(72) Inventors: Enxing HOU, Beijing (CN); Deguo MENG, Beijing (CN); Lijun HEI, Beijing (CN)

(21) Appl. No.: 15/216,706

(22) Filed: Jul. 22, 2016

(30) Foreign Application Priority Data
Aug. 11, 2015 (CN) 201510491263.1

(51) Int. Cl. H04L 12/28; H04W 4/00

(52) U.S. Cl. CPC H04L 12/282; H04W 4/008; H04L 2012/2841; H04L 2012/285

(57) ABSTRACT

A method for controlling a device is provided. The method includes: receiving operation mode configuration information broadcast by a wearable device, in which the operation mode configuration information contains a device identifier corresponding to the wearable device; obtaining an operation parameter corresponding to the device identifier; and operating according to the operation parameter. Accordingly, the smart household device may detect the device identifier of the wearable device, and operate automatically according to the corresponding operation parameter, and thus the user does not need to manually adjust the operation mode of the smart device frequently, which brings convenience to the user.

### CROSS-REFERENCE TO RELATED APPLICATIONS

This application is based on and claims priority to Chinese Patent Application No. 201510491263.1, filed on Aug. 11, 2015, the entire contents of which are incorporated herein by reference.

### TECHNICAL FIELD

The present disclosure relates to communication technology field, and more particularly, to a method for controlling a device and the device thereof.

### BACKGROUND

Various devices emerge with the development of technology and the increase of user demand. Air conditioners, humidifiers and air purifiers are becoming essential household appliances in every home. Usually, user has to adjust the operation parameters of a device (e.g. an air conditioner) manually when using the device, so that the device can operate in an optimal mode for the user, which requires complicated operations and brings about a lot of inconvenience.

### SUMMARY

In order to overcome defects in the related art, embodiments of the present disclosure provide a method for controlling a device and the device thereof.

According to a first aspect of embodiments of the present disclosure, there is provided a method for controlling a device. The method includes: receiving operation mode configuration information broadcast by a wearable device, in which the operation mode configuration information has a device identifier corresponding to the wearable device; obtaining an operation parameter corresponding to the device identifier; and operating according to the operation parameter.

According to a second aspect of embodiments of the present disclosure, there is a device. The device includes: a processor, and a memory configured to store instructions executable by the processor, in which the processor is configured to: receive operation mode configuration information broadcast by a wearable device, the operation mode configuration information having a device identifier corresponding to the wearable device; obtain an operation parameter corresponding to the device identifier; and operate according to the operation parameter.

According to a third aspect of embodiments of the present disclosure, there is provided a system. The system includes: a smart home device configured to receive operation mode configuration information broadcast by a wearable device, the operation mode configuration information having a device identifier corresponding to the wearable device, to obtain an operation parameter corresponding to the device identifier, and to operate according to the operation parameter; and the wearable device, configured to detect a trigger command, and to broadcast the operation mode configuration information in response to the detected trigger command.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is an application scene graph showing a method for controlling a device according to an exemplary embodiment of the present disclosure.

FIG. 2A is a flow chart of a method for controlling a device according to an exemplary embodiment of the present disclosure.

FIG. 2B is a schematic diagram of a smart household application in a smart terminal according to an exemplary embodiment of the present disclosure.

FIG. 3 is a flow chart of a method for controlling a device according to an exemplary embodiment of the present disclosure.

FIG. 4 is a block diagram of an apparatus for controlling a device according to an exemplary embodiment of the present disclosure.

FIG. 5 is a block diagram of another apparatus for controlling a device according to an exemplary embodiment of the present disclosure.

FIG. 6 is a block diagram of another apparatus for controlling a device according to an exemplary embodiment of the present disclosure.

FIG. 7 is a block diagram of another apparatus for controlling a device according to an exemplary embodiment of the present disclosure.

FIG. 8 is a block diagram of an apparatus for controlling a device according to an exemplary embodiment of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items.

It should be understood that terms such as “first,” “second,” and “third” are used herein for describing various information, but the information should not be limited by these terms. The terms are only used for distinguishing the information of the same type from each other. For example, first information may also be called second information, and similarly, the second information may also be called the first information, without departing from the scope of the present disclosure. As used herein, the term “if” may be construed to mean “when” or “upon” or “in response to determining,” depending on the context.

A method for controlling a device according to embodiments of the present disclosure may be applied to adjust operation parameters of a smart household device. The smart household device may include a smart air conditioner, a smart humidifier and a smart air purifier. The operation parameters correspond to each of the specific smart home device. For example, the operation parameters of the smart air conditioner include a mode parameter (refrigerating mode, heating mode, dehumidifying mode, etc.), temperature, air flow speed and air flow direction; the operation parameters of the smart humidifier may include humidity intensity, etc.; the operation parameters of the smart air purifier may include air volume, etc. The method according to embodiments of the present disclosure describes how to realize automatic operation of the smart home device according to the operation parameters set by a user.

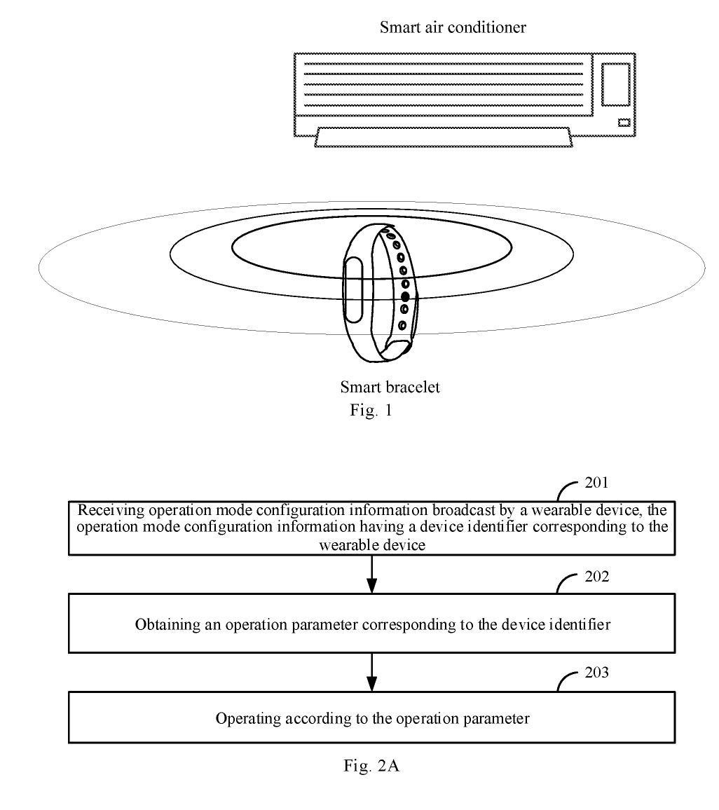

To realize the above objective, embodiments of the present disclosure provide an application scene graph in which the method for controlling a device is applied. Referring to an example of FIG. 1, if it is intended to realize automatic operation according to the operation parameters set by the user, it is necessary to obtain a device identifier of user's wearable device and then obtain the operation parameters corresponding to the device identifier. In such a way, it is possible for the device to operate automatically according to the operation parameters.

Based on the principle, FIG. 1 includes a wearable device used to send the information of operation mode configuration. This embodiment exemplifies the method with a smart bracelet that sends the information of operation mode configuration. In practical applications, the wearable device may be any portable smart device integrated with a communication function, such as a smart hat, a smart watch, smart shoes or a smart ring, which can be worn by the user. FIG. 1 further includes a smart household device. This embodiment exemplifies the method with a smart air conditioner, or other home devices, like a humidifier. The smart household device is used to receive the information of operation mode configuration sent by the wearable device and operate automatically according to the corresponding operation parameter. The wearable device and the smart household device may have a communication component, such as a Bluetooth module or a Wi-Fi network module, and the wearable device and the smart household device may communicate with each other via their communication components.

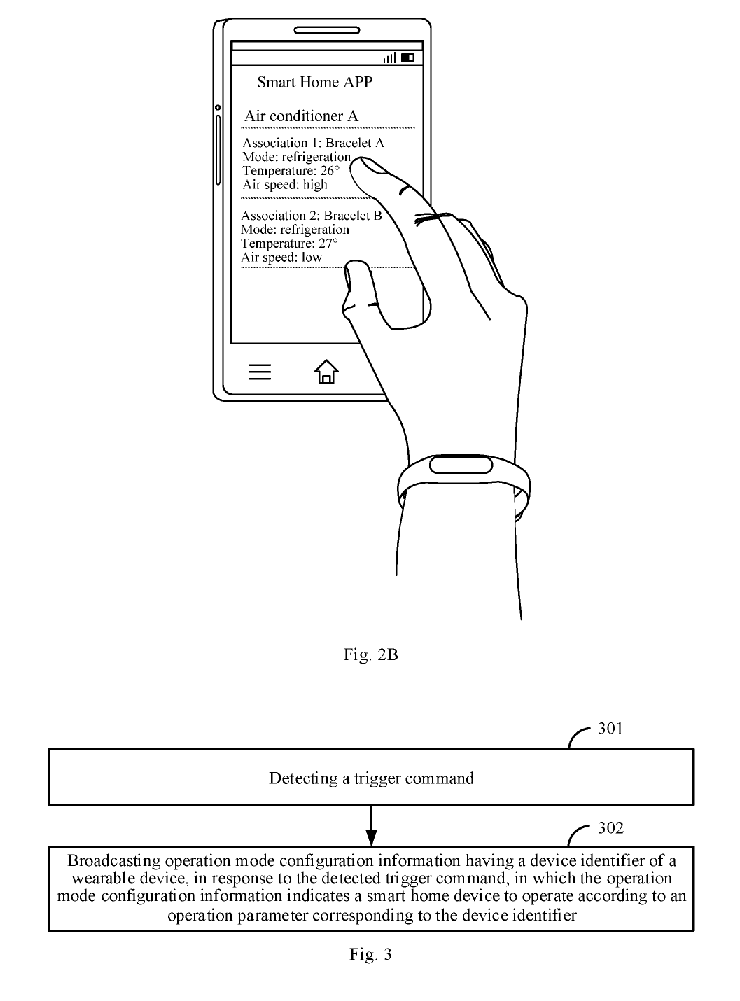

FIG. 2A is a flow chart of a method for controlling a device according to an exemplary embodiment of the present disclosure. As shown in FIG. 2A, the method may be applied in the smart household device in FIG. 1, and include the following steps.

In step 201, the information of operation mode configuration (also referred as “operation mode configuration information”) broadcast by a wearable device is received, in which the information of operation mode configuration includes a device identifier corresponding to the wearable device.

In this embodiment of the present disclosure, each of the smart air conditioner and the smart bracelet may be equipped with a communication component. As an exemplary embodiment, the communication component may be a Bluetooth component. The smart bracelet may broadcast the information of operation mode configuration, and thus within a certain distance range, the smart air conditioner may receive the information of operation mode configuration and obtain the device identifier corresponding to the smart bracelet by analyzing the information.

The device identifier may be identifier information used for identifying the wearable device and carried in the information of operation mode configuration, such as a serial number of the wearable device, an ID of the wearable device, a device name, or a MAC (Media Access Control) address of the information, as long as it may identify the wearable device uniquely, which will not be limited herein.

In step 202, an operation parameter corresponding to the device identifier is obtained.

The smart household device may determine the operation parameter of the corresponding wearable device based on the device identifier carried in the information of operation mode configuration, after receiving the information of operation mode configuration broadcast by the wearable device.

It is possible to obtain the operation parameter corresponding to the device identifier in any of the following methods.

First method: the operation parameter corresponding to the device identifier is obtained from a preset association relationship table showing the correspondence between device identifiers and operation parameters of associated wearable devices.

In this embodiment, the association relationship table is established in advance, and the correspondence between device identifiers and operation parameters of all associated wearable devices is recorded in the association relationship table; the information of operation mode configuration sent by the smart bracelet may only carry the device identifier, and the smart air conditioner searches the association relationship table using the device identifier so as to obtain the corresponding operation parameter.

With respect to the above embodiment, the operation parameter is obtained by using the preset association relationship table, which is easy to implement. Moreover, the information of operation mode configuration sent by the wearable device may only carry the device identifier, which reduces the resource consumed by the wearable device.

The association relationship table may be obtained in the following steps: establishing an association relationship with a wearable device; obtaining the device identifier and the operation parameter of the associated wearable device; and inputting the device identifier and the operation parameter in the association relationship table.

In this embodiment, in order to establish the association relationship of the wearable device, a smart terminal may be used to establish the association relationship between the wearable device and the smart household device, or the wearable device and the smart household device may directly establish the association relationship between themselves. The following embodiments will illustrate the two manners for establishing the association relationship respectively.

First manner: the smart terminal is used to establish the association relationship between the wearable device and the smart home device.

In this embodiment of the present disclosure, the smart terminal may be a smart phone, a tablet computer, a personal digital assistant (PDA), an e-book reader, a multimedia player, etc. Usually, when the user uses the smart terminal to establish the association between the wearable device and the smart household device, this process is realized by client software installed in the smart terminal. For example, in an implementation, the client software may be a “Smart Home” application, and the user may obtain corresponding permissions by establishing a binding relationship with the smart household device and the wearable device at the home respectively via the application. After the binding relationships are established, the user may use the application for centralized management and control of the smart household device and the wearable device.

For example, as shown in FIG. 2B that is a schematic diagram of a smart household application in a smart terminal, the user establishes the association relationship between a smart air conditioner A and two smart bracelets (smart bracelet A and smart bracelet B). The user may associate the air conditioner A with the smart bracelets A and B via the application, and may set corresponding operation parameters (such as temperature, mode and air flow speed of the air conditioner) for each smart bracelet.

After the association is established, for the two smart bracelets associated with the air conditioner A, the smart terminal may send device identifiers of the smart bracelets A and B and the operation parameters set for each smart bracelet to the air conditioner A, and the air conditioner A receives and stores the above information in the association relationship table.

The smart terminal may send both the device identifiers and the operation parameters of the smart bracelets to the smart air conditioner. The smart bracelet may have its own device identifier carried in the information of operation mode configuration it sends. The smart air conditioner may search the association relationship table to find the corresponding operation parameters after receiving the information of operation mode configuration which contains the device identifier of the smart bracelet.

Second manner: the wearable device and the smart home device directly establish the association between themselves.

In this embodiment of the present disclosure, the wearable device may be matched with the smart household device, for example, via a Bluetooth communication component or a NFC (Near Field Communication) component.

For example, for the smart air conditioner, a matching option set in its remote control may be utilized. The smart air conditioner as a master device in the matching connection starts establishing the matching connection with the wearable device as a slave device after the user selects the matching option. During the matching connection, both the smart air conditioner and the wearable device open the Bluetooth function, such that the smart air conditioner searches for the matching information of the wearable device and the wearable device broadcasts its device identifier via Bluetooth. The smart air conditioner records the device identifier after finding the device identifier sent by the smart bracelet, thus completing the matching process.

After the Bluetooth matching is successful achieved, the user may set the corresponding operation parameter for the bracelet via the remote control and the smart air conditioner may store the device identifier and the operation parameter in the association relationship table. Hence, the smart bracelet may have its own device identifier in the information of operation mode configuration carried in the information it sends, and then the smart air conditioner may search the association relationship table to find out the corresponding operation parameter after receiving the information of operation mode configuration, which contains the device identifier of the smart bracelet.

In the above embodiment, the smart household device may establish the association relationship with the wearable device in advance, and store the device identifier and the operation parameter of the associated wearable device in the association relationship table. This method is easy to implement, and the information of operation mode configuration sent by the wearable device only needs to include the device identifier, which reduces the resource consumed by the wearable device.

Second method: the operation parameter corresponding to the device identifier is obtained from the information of operation mode configuration.

In this embodiment, the information of operation mode configuration of the wearable device may carry its own device identifier as well as the operation parameter preset by the user. The preset operation parameter in the wearable device may be sent by the smart terminal to the wearable device for storage or be sent by the smart household device to the wearable device for storage, after the association relationship is established between the wearable device and the smart household device, as illustrated in the first method.

According to the above embodiment, the smart home device may directly analyze the device identifier and the operation parameter upon receiving the information of operation mode configuration, so it is possible to determine the operation parameter of the corresponding wearable device quickly, thus improving the working efficiency.

In an alternative implementation, the steps of obtaining the operation parameter corresponding to the device identifier include: obtaining the operation parameter corresponding to the device identifier, in response to determining that the wearable device is an associated device based on the device identifier.

In this embodiment of the present disclosure, it is possible to determine whether the wearable device is an associated device based on the device identifier; if the wearable device is determined as the associated device, it means that the wearable device has the authority to control the smart household device which further obtains the operation parameter corresponding to the wearable device for operation. If the wearable device is not the associated device, it means that the wearable device has no control authority.

According to the above embodiment, it is first determined that the wearable device is the associated device according to the device identifier, before the operation parameter corresponding to the device identifier is obtained, which may improve the security performance of the smart household device.

In an alternative implementation, the steps of obtaining the operation parameter corresponding to the device identifier include: obtaining the operation parameter corresponding to the device identifier, in response to determining that the wearable device is located within a preset range.

In this embodiment of the present disclosure, it is possible to determine the distance from the wearable device to the smart household device; if the distance is far beyond the preset range, the wearable device may be ignored and only wearable devices in a short distance from the smart household device are considered. The preset range may be an area with a radius of 3-meter or 5-meter, and may be adjusted according to requirements in practical use, which will not be limited herein.

Before obtaining the operation parameter corresponding to the device identifier in response to determining that the wearable device is located within a preset range, a RSSI (Received Signal Strength Indication) may be obtained when receiving the information of operation mode configuration. The wearable device may be determined within the preset range, in response to determining that the RSSI is higher than a preset strength threshold.

In this embodiment of the present disclosure, the RSSI may be obtained when the information of operation mode configuration sent by the wearable device is received. If the strength is high, it may be determined that the wearable device is close to the smart household device; if the strength is low, it may be determined that the wearable device is far away from the smart household device. In practical application, the strength threshold may be set accordingly by those skilled in the art according to the demands.

It shall be noted that the two implementations for obtaining priority levels and operation parameters corresponding to the device identifier (determining whether each wearable device is an associated wearable device and determining whether each wearable device is located within a preset range) may be executed individually in parallel or concurrently in practical use. When the two implementations are executed concurrently, the execution sequence may be adjusted. That is, the step of determining whether each wearable device is an associated wearable device may be performed before or after the step of determining whether each wearable device is located within a preset range.

According to the above embodiment, the corresponding operation parameter is further obtained after the wearable device is determined to be within a close range, which facilitates flexible control on the operation of the smart household device and thus brings convenience to the user.

In step 203, operation is performed according to the operation parameter.

The smart household device may operate according to the operation parameter upon obtaining the operation parameter corresponding to the device identifier. According to the above embodiment, the smart household device may operate using the corresponding operation parameter automatically, after the device identifier of the wearable device is detected, and thus the user does not have to manually adjust the operation mode of the smart device frequently, which facilitates convenience for the user.

FIG. 3 is a flow chart of a method for controlling a device according to an exemplary embodiment. As shown in FIG. 3, the method may be applied to the wearable device in FIG. 1, and include the following steps.

In step 301, a trigger command is detected.

When the user needs to adjust an smart household device—making the smart household device operate according to an operation parameter preset by the user, the user may input the trigger command to a wearable device which the user takes along, and the wearable device sends the information of operation mode configuration to the smart household device after receiving the trigger command.

In step 302, the information of operation mode configuration containing a device identifier of the wearable device is broadcast, in response to the detected trigger command. The information of operation mode configuration indicates the smart household device to operate according to the operation parameter corresponding to the device identifier.

As for in response to the detected trigger command, it may include: in response to detecting that the wearable device is tapped for a preset number of times; or in response to detecting that the wearable device is shaken for a preset number of times.

For example, when the user taps the wearable device twice or shakes the wearable device for three times, the trigger command is ascertained to be received, and the preset information of operation mode configuration containing the device identifier of the wearable device is broadcast, such that the smart household device operates according to the operation parameter corresponding to the device identifier after receiving the information of operation mode configuration.

In the above embodiment, the user performs simple operations, and the wearable device sends the information of operation mode configuration rapidly for controlling smart household device. This method is simple to implement and thus brings convenience to the user.

In this embodiment of the present disclosure, the wearable device may send out the information of operation mode configuration containing the device identifier automatically after receiving the trigger command input by the user, and indicate the smart household device to operate according to the operation parameter corresponding to the device identifier based on the information of operation mode configuration. In this embodiment, the user doesn't have to manually adjust the operation mode of the smart device frequently, which facilitates convenience for the user.

In an alternative implementation, the information of operation mode configuration further includes the operation parameter corresponding to the device identifier.

In this embodiment, the information of operation mode configuration of the wearable device may carry its own device identifier and the preset operation parameter. The wearable device may establish the association relationship with the smart household device in advance, and then receive the operation parameter sent by the smart terminal or sent by the smart household device for storage after the association relationship is established.

According to the above embodiment, since the information of operation mode configuration of the wearable device also carries the preset operation parameter, the smart household device may directly analyze the device identifier and the operation parameter upon receiving the information of operation mode configuration, and thus it is possible to determine the operation parameter corresponding to the wearable device quickly, thus improving the working efficiency.

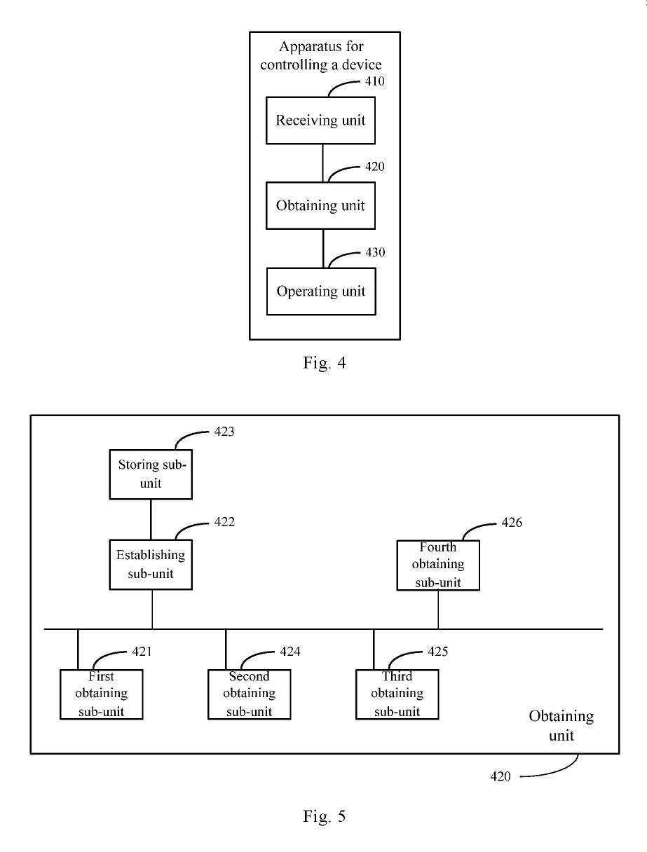

FIG. 4 is a block diagram of an apparatus for controlling a device according to an exemplary embodiment of the present disclosure. As shown in FIG. 4, the apparatus includes a receiving unit 410, an obtaining unit 420 and an operating unit 430.

The receiving unit 410 is configured to receive information of operation mode configuration broadcast by a wearable device, wherein the information of operation mode configuration includes a device identifier corresponding to the wearable device.

The obtaining unit 420 is configured to obtain an operation parameter corresponding to the device identifier received by the receiving unit 410.

The operating unit 430 is configured to operate according to the operation parameter obtained by the obtaining unit 420.

According to the above embodiment, the wearable device sends out the information of operation mode configuration, which contains the device identifier. The smart household device may obtain the operation parameter corresponding to the device identifier and operate using the operation parameter. In the present disclosure, the smart device may operate automatically according to the corresponding operation parameter after the device identifier of the wearable device is detected, and thus the user does not need to manually adjust the operation mode of the smart device frequently, which facilitates convenience for the user.

FIG. 5 is a block diagram of another apparatus for controlling a device according to an exemplary embodiment of the present disclosure. As shown in FIG. 5, based on the embodiment shown in FIG. 4, the obtaining unit 420 includes a first obtaining sub-unit 421 configured to obtain the operation parameter corresponding to the device identifier received by the receiving unit 410 based on a preset association relationship table showing the correspondence between device identifiers and operation parameters of associated wearable devices.

According to the above embodiment in the present disclosure, the operation parameter is obtained from the preset association relationship table, which is easy to implement, and the information of operation mode configuration sent by the wearable device only needs to contain the device identifier, which reduces the resource consumed by the wearable device.

In an embodiment, the obtaining unit 420 further includes an establishing sub-unit 422 and a storing sub-unit 423.

The establishing sub-unit 422 is configured to establish an association relationship with a wearable device.

The storing sub-unit 423 is configured to obtain the device identifier and the operation parameter of the associated wearable device in the establishing sub-unit 422, and input the device identifier and the operation parameter in the association relationship table.

According to the above embodiment, the smart household device in the present disclosure may establish the association relationship with the wearable device in advance and store the device identifier and the operation parameter of the associated wearable device in the association relationship table. This method is easy to implement, and the information of operation mode configuration sent by the wearable device only needs to carry the device identifier, which reduces the resource consumed by the wearable device.

In an embodiment, the obtaining unit 420 further includes a second obtaining sub-unit 424 configured to obtain the operation parameter corresponding to the device identifier from the information of operation mode configuration received by the receiving unit 410.

According to the above embodiment, the smart household device in the present disclosure may directly analyze the device identifier and the operation parameter upon receiving the information of operation mode configuration, so it is possible to determine the operation parameter corresponding to the wearable device quickly, thus improving the working efficiency.

In an embodiment, the obtaining unit 420 further includes a third obtaining sub-unit 425 configured to obtain the operation parameter corresponding to the device identifier, in response to determining that the wearable device is an associated device according to the device identifier received by the receiving unit 410.

According to the above embodiment, in the present disclosure, it is first determined that the wearable device is the associated device according to the device identifier, before the operation parameter corresponding to the device identifier is obtained, which may improve the security performance of the smart household device.

In an embodiment, the obtaining unit 420 further includes a fourth obtaining sub-unit 426 configured to obtain the operation parameter corresponding to the device identifier received by the receiving unit 410, in response to determining that the wearable device is located within a preset range.

According to the above embodiment, the corresponding operation parameter is further obtained after it is determined that the wearable device is within a close range, which facilitates flexible control on the operation of the smart household device and thus facilitates convenience for the user.

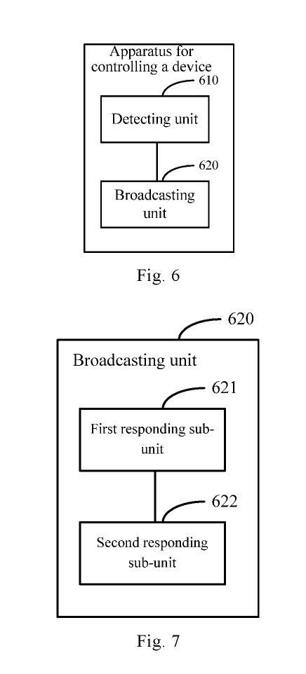

FIG. 6 is a block diagram of another apparatus for controlling a device according to an exemplary embodiment of the present disclosure. As shown in FIG. 6, the apparatus includes a detecting unit 610 and a broadcasting unit 620.

The detecting unit 610 is configured to detect a trigger command.

The broadcasting unit 620 is configured to broadcast the information of operation mode configuration, which contains a device identifier of a wearable device, in response to the trigger command detected by the detecting unit 610. The information of operation mode configuration instructs a smart household device to operate according to an operation parameter corresponding to the device identifier.

According to the above embodiment, the wearable device in the present disclosure may send out the information of operation mode configuration containing the device identifier automatically upon receiving the trigger command from the user; the information of operation mode configuration instructs the smart household device to operate according to the operation parameter corresponding to the device identifier. In the present disclosure, the user doesn't have to manually adjust the operation mode of the smart device frequently, which facilitates convenience for the user.

FIG. 7 is a block diagram of another apparatus for controlling a device according to an exemplary embodiment of the present disclosure. As shown in FIG. 7, based on the embodiment shown in FIG. 6, the broadcasting unit 620 includes any one of a first responding sub-unit 621 and a second responding sub-unit 622. For the sake of illustration, both the above two sub-units are shown in FIG. 7.

The first responding sub-unit 621 is configured to respond to detecting that the wearable device is tapped for a preset number of times.

The second responding sub-unit 622 is configured to respond to detecting that the wearable device is shaken for a preset number of times.

According to the above embodiment, after the user performs simple operations, the wearable device nay send the information of operation mode configuration right away for controlling the household device. This is simple to implement and thus facilitates convenience for the user.

In an embodiment, the information of operation mode configuration further includes the operation parameter corresponding to the device identifier.

According to the above embodiment, since the information of operation mode configuration of the wearable device also includes the preset operation parameter, the smart household device may directly analyze the device identifier and the operation parameter upon receiving the information of operation mode configuration, and thus it is possible to determine the operation parameter corresponding to the wearable device quickly, thus improving the working efficiency.

Accordingly, the present disclosure further provides an apparatus. The apparatus includes a processor, and a memory configured to store instructions executable by the processor, in which the processor is configured to: receive the information of operation mode configuration broadcast by a wearable device, wherein the operation mode configuration information includes a device identifier corresponding to the wearable device; obtain an operation parameter corresponding to the device identifier; and operate using the operation parameter.

Accordingly, the present disclosure further provides an apparatus. The apparatus includes a processor, and a memory configured to store instructions executable by the processor, in which the processor is configured to: detect a trigger command; and broadcast the information of operation mode configuration, which contains a device identifier of a wearable device, in response to the detected trigger command. The information of operation mode configuration instructs a smart home device to operate according to an operation parameter corresponding to the device identifier.

Accordingly, the present disclosure further provides a system for controlling a device. The system includes: a smart household device configured to receive information of operation mode configuration broadcast by a wearable device, wherein the information of operation mode configuration contains a device identifier corresponding to the wearable device, to obtain an operation parameter corresponding to the device identifier, and to operate according to the operation parameter; and the wearable device configured to detect a trigger command, and to broadcast the information of operation mode configuration in response to the detected trigger command.

With respect to the apparatuses in the above embodiments, the specific manners for performing functions and operations for individual units therein have been described in detail in the embodiments regarding the methods for controlling devices, which will not be elaborated herein.

The apparatus embodiment is substantially related to the method embodiment, so the relevant parts can be referred to the illustration of the method embodiment. The apparatus embodiment described above is only exemplary, in which the units described as separate components may be or may not be physically separate; the component as the displaying unit may be or not be a physical unit, i.e. may be located at one position or be distributed at many network elements. It is possible to select part of or all of the modules to realize the objective of the present disclosure, which may be understood and implemented by those skilled in the art without making any creative effort.

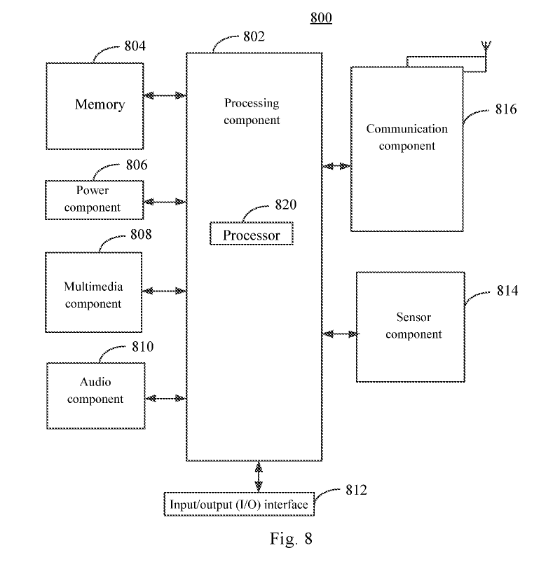

FIG. 8 is a block diagram of an apparatus 800 for controlling a device according to an example embodiment of the present disclosure. For example, the apparatus 800 may be a mobile phone, a computer, a digital broadcasting terminal, message sending and receiving equipment, a game controller, a tablet device, a medical device, fitness equipment and a personal digital assistant.

Referring to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the apparatus 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800.

The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identifier (RFID) technology, an infrared data association (IrDA) technology, an ultra-wideband (UWB) technology, a Bluetooth (BT) technology, and other technologies.

In example embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as included in the memory 804, executable by the processor 820 in the apparatus 800, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium has stored therein instructions that, when executed by a processor of a mobile terminal, cause the mobile terminal to perform a method for controlling a device.

Other embodiments of the present disclosure will be apparent to those skilled in the art from consideration of the specification and practice of the disclosure disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

Part of embodiments of the present disclosure is mentioned in the above and is not construed to limit the present disclosure. Any modification, alternatives and improvements within the spirit and principle of the present disclosure shall be contained in the protection scope of the present disclosure.

What is claimed is:

1. A method for controlling a device, comprising:
receiving operation mode configuration information broadcast by a wearable device, the operation mode configuration information comprising a device identifier corresponding to the wearable device;
obtaining an operation parameter corresponding to the device identifier; and
operating according to the operation parameter.

2. The method according to claim 1, wherein obtaining the operation parameter corresponding to the device identifier comprises:
obtaining the operation parameter corresponding to the device identifier from a preset association relationship table recording correspondence between device identifiers and operation parameters of associated wearable devices.

3. The method according to claim 2, further comprising:
establishing an association relationship with a wearable device;
obtaining the device identifier and the operation parameter of the associated wearable device, and storing the device identifier and the operation parameter in the association relationship table.

4. The method according to claim 1, wherein obtaining the operation parameter corresponding to the device identifier comprises:
obtaining the operation parameter corresponding to the device identifier from the operation mode configuration information.

5. The method according to claim 1, wherein obtaining the operation parameter corresponding to the device identifier comprises:
obtaining the operation parameter corresponding to the device identifier, in response to determining that the wearable device is an associated device according to the device identifier.

6. The method according to claim 1, wherein obtaining the operation parameter corresponding to the device identifier comprises:
obtaining the operation parameter corresponding to the device identifier, in response to determining that the wearable device is located within a preset range.

7. A device, comprising:
a processor; and
a memory, configured to store instructions executable by the processor,
wherein the processor is configured to:
receive operation mode configuration information broadcast by a wearable device, the operation mode configuration information comprising a device identifier corresponding to the wearable device;
obtain an operation parameter corresponding to the device identifier; and
operate according to the operation parameter.

8. The device according to claim 7, wherein the processor is configured to:
obtain the operation parameter corresponding to the device identifier from a preset association relationship table recording correspondence between device identifiers and operation parameters of associated wearable devices.

9. The device according to claim 8, wherein the processor is further configured to:
establish an association relationship with a wearable device; and
obtain the device identifier and the operation parameter of the associated wearable device, and store the device identifier and the operation parameter in the association relationship table.

10. The device according to claim 7, wherein the processor is configured to:
obtain the operation parameter corresponding to the device identifier from the operation mode configuration information.

11. The device according to claim 7, wherein the processor is configured to:
obtain the operation parameter corresponding to the device identifier, in response to determining that the wearable device is an associated device according to the device identifier.

12. The device according to claim 7, wherein the processor is configured to:
obtain the operation parameter corresponding to the device identifier, in response to determining that the wearable device is located within a preset range.

13. A system, comprising:
a smart household device, configured to receive operation mode configuration information broadcast by a wearable device, obtain an operation parameter corresponding to the device identifier, and operate according to the operation parameter, wherein the operation mode configuration information comprises a device identifier corresponding to the wearable device; and
the wearable device, configured to detect a trigger command, and to broadcast the operation mode configuration information in response to the detected trigger command.

14. The system according to claim 13, wherein the smart household device is configured to obtain the operation parameter corresponding to the device identifier from a preset association relationship table recording correspondence between device identifiers and operation parameters of associated wearable devices.

15. The system according to claim 14, wherein the smart household device is configured to establish an association relationship with the wearable device, to obtain the device identifier and the operation parameter of the associated wearable device, and to store the device identifier and the operation parameter in the association relationship table.

16. The system according to claim 13, wherein the smart household device is configured to obtain the operation parameter corresponding to the device identifier from the operation mode configuration information.

17. The system according to claim 13, wherein the smart household device is configured to obtain the operation parameter corresponding to the device identifier, in response to determining that the wearable device is an associated device according to the device identifier.

18. The system according to claim 13, wherein the smart household device is configured to obtain the operation parameter corresponding to the device identifier, in response to determining that the wearable device is located within a preset range.

19. The system according to claim 13, wherein the wearable device is configured to broadcast the operation mode configuration information in response to detecting being tapped for a preset number of times or being shaken for a preset number of times.
